(19) United States
(12) Patent Application Publication
(10) Pub. No.: US 2008/0142287 A1
(43) Pub. Date: Jun. 19, 2008

(54) Liquified Fuel Gas Powered Recreational Vehicle

(76) Inventors: Val J. Simmons, Providence, UT (US); Steven Bensen, Providence, UT (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/934,469

(22) Filed: Nov. 2, 2007

Related U.S. Application Data
(60) Provisional application No. 60/864,161, filed on Nov. 2, 2006.

(51) Int. Cl. B62D 55/00; F02M 37/00

(52) U.S. Cl. 180/186; 123/434

(57) ABSTRACT

An engine system for a motor vehicle including a source of pressurized fuel and an intake system having one or more of a converter unit, a mixer unit, a pressure balance line, and a primer system. The pressure balance line may be configured with offset access to an air stream within the charge tube during operation, leading to improved overall responsiveness of the engine system. A snowmobile and personal watercraft are two motor vehicles finding particular utility for the engine system.

### RELATED APPLICATIONS

This application claims priority under 35 U.S.C. 119(e) from provisional U.S. Patent Application No. 60/864,161, filed Nov. 2, 2006, the contents of which are incorporated herein by reference.

### FIELD OF THE INVENTION

The present invention relates generally to motorized recreational vehicles and more particularly to snowmobiles, personal watercraft, all terrain vehicles, motorcycles and the like.

### BACKGROUND OF THE INVENTION

Conventional snowmobiles have used two-cycle engines. Two-cycle engines are characterized by a relatively simple engine configuration having the advantages of being lightweight and compact and still providing high power. When used to power a snowmobile, other desirable characteristics of two-cycle engines include the relative simplicity of the engine and relatively high power-to-weight and power-to-size ratios of these engines.

Current trends and regulations demand a quiet, clean and environment-friendly engine for use with recreational motor vehicles. In some settings, four-cycle engines have been utilized as alternative power sources. In general, two-stroke engines inherently have higher exhaust emissions than comparably sized four-cycle engines due to: 1) the necessity of opening the exhaust ports subsequent to complete ignition of the fuel/air mixture, 2) unburned fuel escaping the exhaust port during the intake cycle of the cylinder, and 3) lubrication oil mixing with the intake air.

While four-cycle engines are now widely found on outdoor power equipment and vehicles, for example, snowthrowers, lawnmovers, all terrain vehicles, motorcycles, etc., these engines have substantial limitations. For example, four-cycle engines are less desirable for powering snowmobiles due to the low power-to-weight/size ratios, as four-cycle engines are heavier than comparable two-cycle engines. Snowmobile handing and performance characteristics are sensitive to weight increases. Additionally, the relatively compact chassis and body of a snowmobile limits the space available for the engine.

The rapidly rising cost of gasoline and stricter emission controls have encouraged interest in the use of alternative fuels in engines instead of gasoline. One of the alternatives is a class of fuels referred to as gaseous fuels. Examples of these fuels are liquefied petroleum gases (LPG) containing propane or butane or mixtures of both, and liquefied natural gas (LNG). It is understood that reference herein to propane or LPG is meant to include any or all of the gaseous fuels.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying FIGURES. It is to be expressly understood, however, that each of the FIGURES is provided for the purpose of illustration and description only and is not intended as a definition of the limits of the present invention.

### SUMMARY OF THE INVENTION

The invention relates to a recreational motor vehicle, such as a snowmobile, personal watercraft, all terrain vehicle (ATV) and the like, with an internal combustion engine which is fueled with a liquefied fuel gas, such as, for example, liquefied propane (LP).

In one embodiment, internal combustion engine is provided with pressurized intake air from, for example, a supercharger or turbocharger. In other embodiments, the engine uses atmospheric air. A snowmobile may include an air charging system and an intercooler system.

In one embodiment, the present invention contemplates a snowmobile having a chassis that includes a track tunnel portion; a track located within the tunnel portion; and an engine mounted to the chassis, and including an air intake assembly and an exhaust assembly.

An especially desirable characteristic of propane-powered engines is the substantial reduction in emissions. The present invention minimizes many of the problems associated with two-cycle and conventional four cycle engines and makes it possible to use gaseous fuels effectively, economically, and efficiently in internal combustion engines of recreational motor vehicles.

In one embodiment, the present invention contemplates a snowmobile having a pressurized fuel tank located between the operator seat and the track tunnel portion. Such a tank may include a plurality of cylindrical tanks. In another embodiment, the present invention contemplates a personal watercraft having a pressurized fuel tank located underneath the operator seat or in the bow or front portion of the watercraft.

Embodiments of the present invention provide a recreational motor vehicle which utilizes a gaseous fuel IC engine as an alternative to conventional gasoline-powered two-cycle and four cycle engines, while producing sufficient engine output, and remaining relatively small and light weight.

Another advantage of an embodiment of the present invention is that the charged air engine in the recreational motor vehicle need not require a premium grade of gasoline to operate properly.

An added advantage of an embodiment of the present invention is that the engine cold starting capability is improved since the fuel will enters the engine as a pre-mixed gaseous vapor.

Another advantage of an embodiment of the present invention is that there is minimal turbo lag in the system since the total air volume in the engine system is kept to a minimum.

A further advantage of an embodiment of the present invention is that the intercooler system for the air charger is effective even during operation of the snowmobile under high engine load, low forward speed conditions, such as when climbing a hill.

### BRIEF DESCRIPTION OF THE DRAWINGS

FIG. 1 is an elevational view of a depiction of a snowmobile embodying the principles of the present invention.

FIG. 2 is a schematic view of the air intake system of the present invention.

FIG. 3 is a perspective view of a component of an air intake of FIG. 2.

FIG. 4 is a perspective view of a component of an air intake system of FIG. 2.

FIG. 5 is a schematic view of a component of an air intake system of FIG. 2.

FIG. 6 is a bottom elevational view of a component of an air intake system of FIG. 2.

FIG. 7 is a cross-sectional depiction of the component of FIG. 6 taken through a centerline.

FIG. 8 is a top elevational view of a component of an air intake system of FIG. 2.

FIG. 9 is a schematic illustration of another embodiment of an air intake system according to the present invention.

FIGS. 10-13 are perspective views of a snowmobile incorporating aspects of the present invention.

FIGS. 14-16 are various schematic views of alternative embodiments of an air intake system in accordance with the present invention.

### DETAILED DESCRIPTION OF THE INVENTION

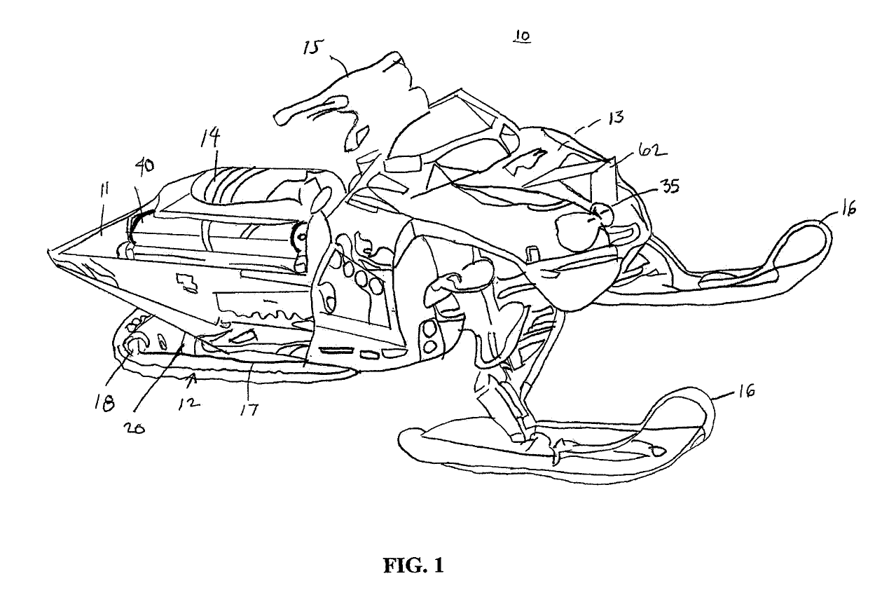

FIG. 1 shows a snowmobile 10 embodying the principles of the present invention. Snowmobile 10 has a frame 11 and an endless driven track system 12 mounted to a rearward portion of frame 11. Snowmobile 10 utilizes an internal combustion engine indicated at 13 to provide power generation. Engine 13 is operatively connected to the belt drive system 12 to provide movement to snowmobile 10. Snowmobile 10 includes a seat 14 whereon a driver may be positioned in a seated manner. The driver straddles seat 14 during use and foot rests are provided by side steps 19. A steering assembly 15 is located forward of seat 14 and is operatively coupled to a pair of skis 16 providing steering capability to snowmobile 10. Engine 13 will include some type of engine cooling system, which may employ, for example, air cooling or liquid cooling, but this system does not form part of the present invention, and can be conventional in nature, so it will not be discussed further herein. While the illustrated preferred embodiment of the present invention is a snowmobile, it is envisioned that the present invention could also be embodied within a variety of different recreational motor vehicles, such as, but not limited to, personal water craft and all terrain vehicles (ATV).

As described in more detail herein, snowmobile 10 includes a propane fueled engine providing heretofore unattainable performance characteristics while providing a substantial reduction in emissions. Given the air and noise pollution generated by two-cycle engines, current regulations restrict access to certain federal areas and/or National Parks to four cycle snowmobiles. It is envisioned that embodiments of snowmobiles of the present invention would provide an even greater reduction in emissions as compared to four-cycle snowmobile engines. Future snowmobile access in such protected areas may be further restricted to embodiments of the present invention, especially given the substantial reduction of air and noise emissions.

Track system 12 includes a drive track 17, a drive wheel (not shown) arranged near engine 13, idler wheels 18 arranged near the rear end of frame 11. Track system 12 also includes a suspension mechanism 20. A frame tunnel is positioned between components of track system 12 and suspension system 20 and seat 14.

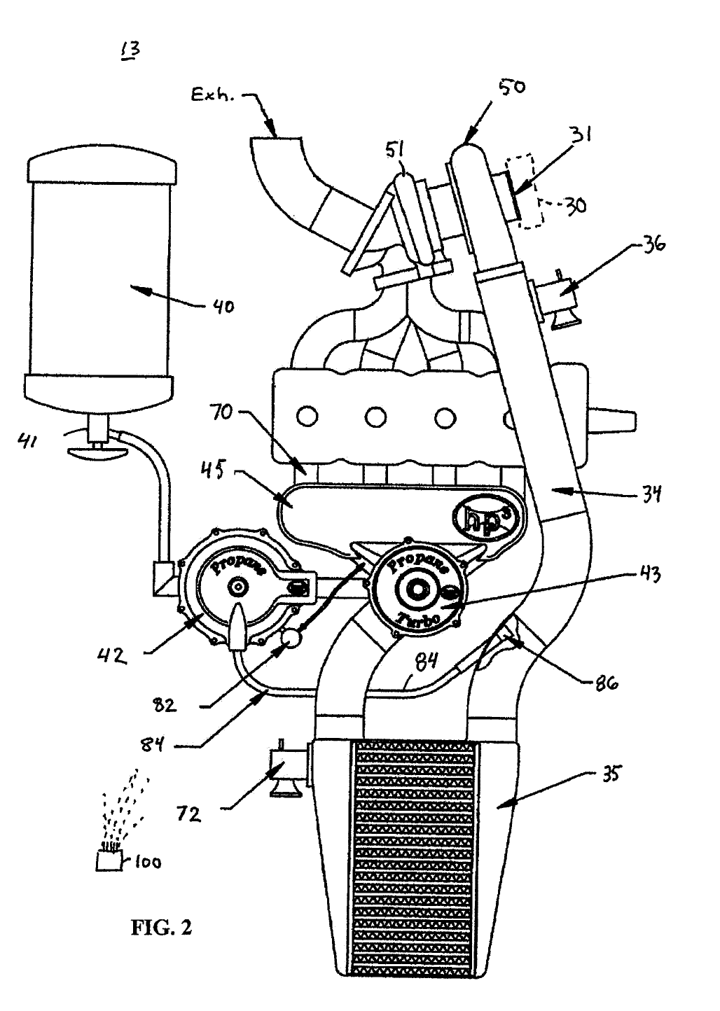

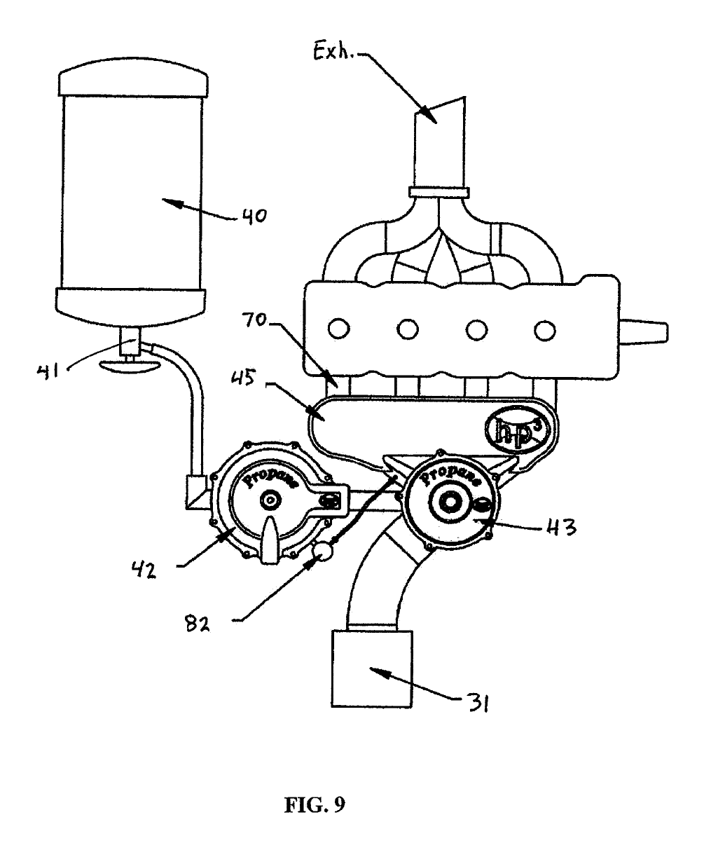

One embodiment of an engine system of the present invention is shown schematically in FIG. 2. As shown in FIG. 2, air from the atmosphere enters an air filter 30, flows through conduit 31 and enters turbocharger 32. Turbocharger 32 compresses the intake air. Intake air temperature increases due to heat generation during the compression process. While this embodiment includes turbocharger 32, alternative embodiments of the present invention may be naturally aspirated, such as depicted in FIG. 9.

Referring again to FIG. 2, temperature and pressure of the air exiting turbocharger 32 are greater than a pressure and temperature of the air entering the turbocharger 32. The heated and pressurized air then flows through charge tube 34 toward mixer 43. Bypass valve (waste gate) 36 is a pressure relief valve. The compressed air passes into intercooler 35 prior to being combined with fuel at mixer 43. Intercooler 35 is arranged to remove heat from the pressurized intake air such that at an exit point, the temperature of the air is less than the temperature of the air at the entrance point. Fuel, such as propane, is provided by tank 40 and passes through valve 41 prior to introduction into heat exchanger/converter 42. Plenum 45 receives the cooled, compressed intake air/fuel mixture from converter 42 and passes it into throttle bodies 70 of engine 13. Exhaust gases exit engine 13 and are directed to turbocharger 32 and exit snowmobile 10 through an exhaust system, which may include a muffler (not shown).

Heat exchanger/converter 42 warms the liquefied fuel gas from its cold state to a temperature that permits more efficient operation of internal combustion engine 13. It another embodiment, it may be possible to combine all or portions of heat exchanger/converter 42 with intercooler 35 to provide a heat exchange system which is more compact. In a preferred example, heat exchanger/converter 42 is a LPG vaporizer with built-in regulation, such as manufactured by IMPCO, Technologies of Santa Ana, Calif. The IMPCO converter is a combined two-stage regulator and vaporizer. In general, it receives liquid fuel at tank pressure from the filter/fuel lock and reduces pressure in two stages to slightly less than atmospheric. When the engine is cranking or running, a partial vacuum is created in the vapor line to the carburetor, which opens the regulator permitting fuel to flow to the carburetor. In the process of reducing the pressure in the tank to atmospheric, the liquid propane expands to become a vapor, absorbing heat in the process. Water from the engine cooling system circulates through a heat exchanger to avoid internal freeze up. A regulator seals off fuel flow when the engine is stopped.

As shown in FIG. 2, turbocharger 32 communicates with the outlet of air filter 30 via conduit 31. Conduit 31 is preferably a rigid metallic tubular member with a configuration that allows a relatively direct path from air filter 30 to turbocharger 32. It is contemplated that the configuration of conduit 31 may include one or more bends to accommodate positioning of various engine or snowmobile components and the relative positions of air filter 30 and turbocharger 32. It is also contemplated that conduit 31 may have a flexible metallic configuration or may be formed of plastic material. However, due to the heat present at the relative proximity of engine 13, it is preferable for the conduit 31 to be relatively resistant to high-heat environments.

Turbocharger 32 includes a compressor portion 50 and a turbine portion 51. Compressor portion 50 has an inlet which is connected to conduit 31, as described above, and has an outlet that is connected to conduit 34. Turbine portion 51 includes an inlet and an outlet. Turbocharger 32 utilizes energy provided by engine 13 exhaust to compress (pressurize) air from the atmosphere. For the turbocharger shown in the FIGURES, a rotor of turbine structure 51 is connected to a common rotor of compressor structure 50 so as to rotate in unison therewith. It is noted that any other type of turbocharger may be used, including types that have separate turbines and compressors that are linked, for example by a rigid shaft that extends therebetween.

Bypass valve 36 and blowoff valve 72 control air pressure within the intake system during operation. A pressure setting of valves 36, 72 may be adjustable, for example, to vary performance needs of engine 13. In some embodiments, valves 36, 72 may be controlled by an engine control unit 60, based upon inputs from a charge air temperature and/or pressure sensor, a knock sensor, in addition to other conventional inputs to the engine control unit.

bypass valve 36 is located as close to turbo 32 as possible. Valve 36 controls turbo surge and allows turbo to spool quickly. The exit hole in the charge tube 34 for valve 36 is between ⅞″ ID and 1.250″ ID. Blow off valve 72 is located between intercooler 35 and mixer 43. This positioning allows excess pressure to be quickly released during throttling down so as to prevent over-pressurizing mixer 42 and plenum 45 and thus minimizing the occurrence of a flooded engine condition. The exit hole in charge tube 34 for valve 72 is between ⅜″ ID and 1″ ID.

Tank 40 contains a liquefied fuel gas, such as liquefied propane (LP), liquefied petroleum gas (LPG) or liquefied natural gas (LNG). LP is a preferred fuel gas. A regulator may be used to control gas pressure released from tank 40. Alternatively, a heater/converter unit can be utilized to control gas pressure released from tank 40. The benefits of the use of liquefied fuel gas with turbocharger 43 in conjunction with engine 13 include enhanced performance, improved efficiency and a substantial decrease in emissions.

Heat exchanging intercooler 35 may be located proximate the forward portion of snowmobile 10. It may be optimal for intercooler 35 to be mounted in a different position relative to the movement of air produced from forward movement of snowmobile 10. Intercooler 35 is constructed and arranged to dissipate heat from the pressurized intake air prior to introduction into mixer 43. It is preferable for intercooler 35 to be formed of a heat conductive material such as metal, for example, aluminum or steel and conFIGUREd so as to minimize air flow resistance and pressure loss of the air flowing therein. It is also preferable to keep the size of intercooler 35 to a minimum, to maintain a space efficient design of engine 13.

It is preferable for plenum 45 to be connected to engine air intake in a relatively direct manner, so as to minimize the air travel distance between plenum 45 and engine 13. Plenum 45 may be preferably formed of a metallic material. However, it is contemplated that a rigid polymer material may also be utilized. Plenum 45 is preferably a substantially hollow enclosure, which possesses a relatively small volume. It is noted that the plenum volume may be altered with respect to engine size, engine operating characteristics, and/or turbocharger output.

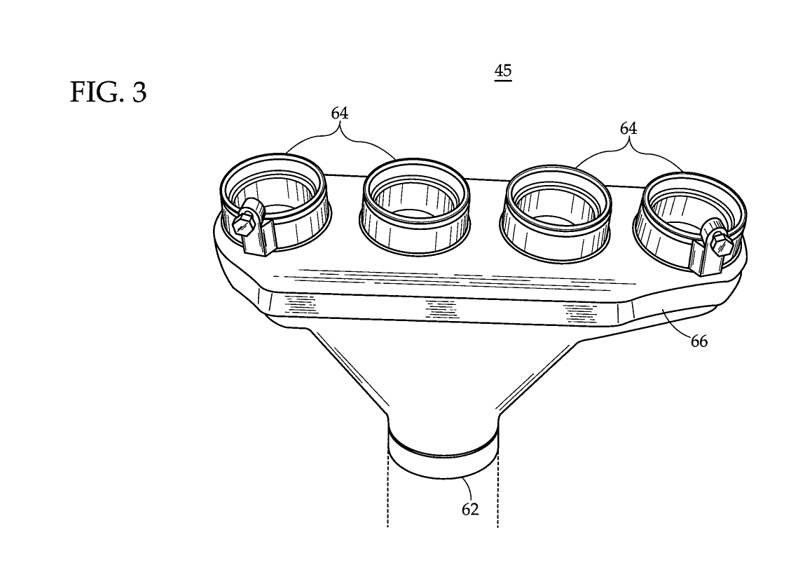

While prior art propane systems place a mixer directly on the throttle body or carburetor via a mounting bracket or plate. A system in accordance with the present invention uses plenum 45 between mixer 43 and the throttle bodies (or carburetor bodies) 70. One embodiment of plenum 45 is shown in FIG. 3. In this embodiment, plenum 45 includes an air/fuel inlet port 62 provided in fluid communication with four outlet ports 64 via interior volume 66. Outlet ports 64 are coupled to throttle bodies 70. Ideally a volume of plenum 45 should be of a specific size in relation to the size of the engine. In another embodiment, plenum 45 could be incorporated as part of the intercooler as long as it is located between the mixer and throttle bodies. This plenum approach works on naturally aspirated motors as well as in conjunction with turbo charged or super charged motors.

It has been determined that a preferred working ratio for the size of the plenum is needed for proper engine performance. On the smaller end of the scale plenum 45 would have a total volumetric size of 11% of the total volume of the engine. On the larger side it would have a volumetric size of 110.6% of the total size of the engine.

Example: Using a 1000 cc motor as a model.

Smallest plenum would be 110 cc or 11% of total cc's of motor.

Largest plenum would measure 11,066.02 cc or 110.6% times the total motor cc's

A more preferred range for plenum 45 sizing would be between 340-700 cc for a 4-cylinder, 1000 cc motor. For a 1000 cc, 3-cylinder motor, a more ideal range of plenum 45 size would be between 255 and 525 cc.

Referring again to FIG. 2, the engine system includes a means for priming the engine during cold starts, etc. Existing propane systems include a primer button on top of a converter cap. This button is designed to give an extra shot of propane directly into the vapor supply line running from the converter to the mixer. Though this factory system works moderately well it is inconvenient to get off the vehicle and reach down under the hood or having to take the hood off in order to reach the button at the same time trying to start the motor. Another limitation of the prior art system is that propane vapor is introduced directly into the mixer. Applicants have determined that other configurations of the priming system are more beneficial during startup.

To better facilitate cold starts, an engine system in accordance with the present invention incorporates primer line 80 which conveys vaporous gas from converter 42 directly into the intake system between mixer 43 and plenum 45. Primer line 80 should either be of a specific inside diameter or an orifice or jet or reducer should be provide in line 80 to allow the proper amount of gaseous vapor to enter the intake tract at the proper time. Line 80 should have a diameter between 0.020″ to 0.099″ I.D. As revealed in testing, a smaller orifice doesn't allow enough fuel to facilitate start up and a line larger than 0.099″ I.D. introduces too much fuel, resulting in flooding.

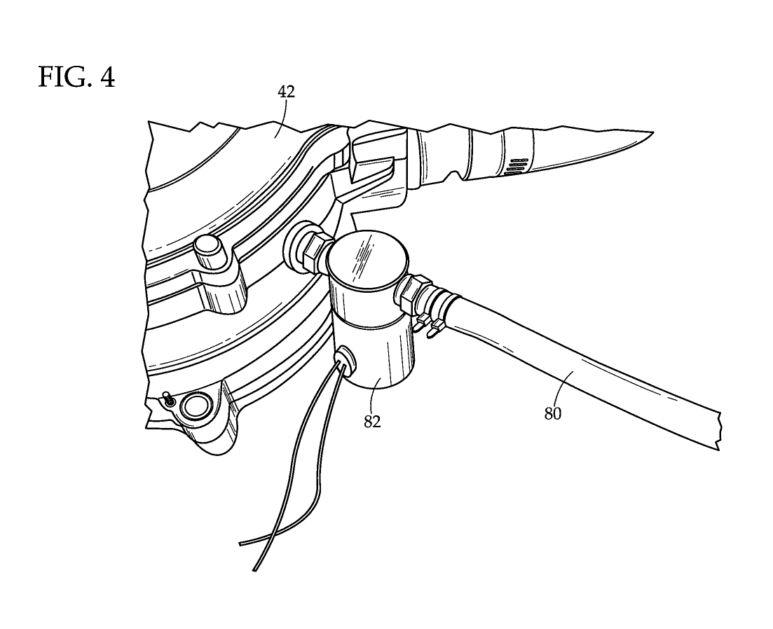

As shown in FIGS. 2 and 4, electric solenoid valve 82 is used to control the fuel to enter at the proper time and then remain shut during operation of engine 13. This may be accomplished by wiring the solenoid valve 82 directly in conjunction with the wiring start up relay system employed by the machine when starting the engine 13. When the engine is being started, a starter motor is activated which turns engine 13 over at a sufficient speed to allow start up. When the start key is released engine 13 will continue to run and the electric primer system will automatically turn off. An optional remote on/off switch may be installed to completely render the primer system inoperative if so desired. For instance, once the motor is warmed up the primer system might not be necessary to facilitate start up.

Balance line 84 is to balance the air pressures between the converter 42 and charge tube 34. Without this air balance, converter 42 is often unable to deliver sufficient quantities of fuel to the engine. As shown in FIG. 9, a naturally aspirated engine does not require this balance line, as converter 42 is already open to atmospheric pressure. Existing systems typically attach a balance line directly to a converter cap at a right angle (perpendicular to the converter diaphragm).

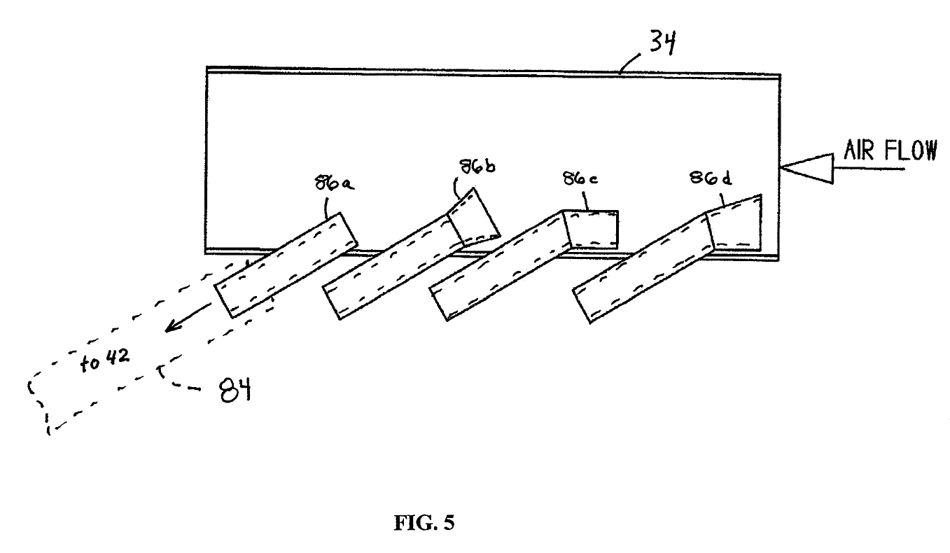

In order to provide improved performance, balance line 84 should be coupled to an interior of charge tube 34. FIG. 5 illustrates various different configurations of an end 86a-86d of balance line 84 as it protrudes into charge tube 34 at an angle relative to the direction of air flow. End 86 of balance line 84 is ideally flared. This shape, location and angle of end 86 cooperate to capture airflow very quickly from the spooling up turbo. In comparison, if end 86 is simply inserted into charge tube 34 at a right angle relative to direction of air flow, balance line 84 may see a vacuum until tube 34 reaches full charge pressure. Even with a high air flow from the turbo, there may be a tendency in the balance line of the prior art to draw a vacuum on line 84 instead of pressurizing it. By configuring and positioning end 86 as shown in FIG. 5, improved engine performance is obtained.

Converter 42 relies on a signal pressure coming through balance line 84 in order to properly deliver the right amount of fuel at the right time. For proper performance, balance line 84 should be between 3/16″ and ⅝″ ID. A line smaller or larger than this delays the pressure signal and thus delays the overall response time. The length of balance line 84 should be as short as possible ranging from 1″ to a maximum of 2.5 ft.

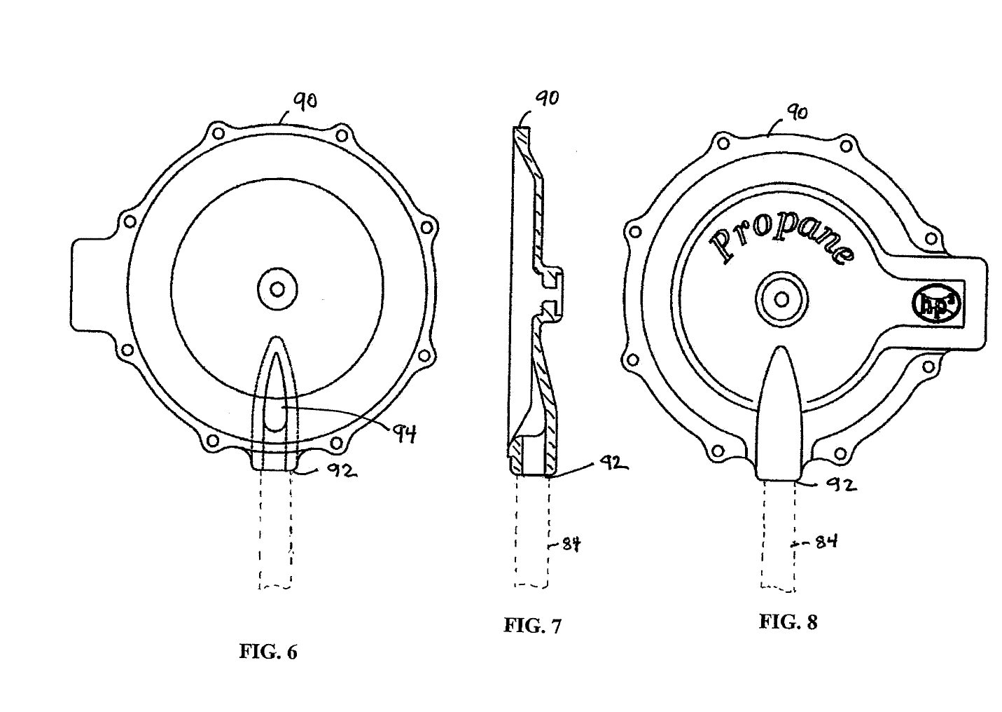

Referring to FIGS. 6-8, applicant has discovered that coupling the other end of line 84 in a generally parallel manner relative to the cap 90 of converter 42 yields optimum results. By providing such a coupling between line 84 and converter 42, the pressure signal is better distributed across the diaphragm within converter 42. In comparison, the prior art approach having a 90 degree angle (of air flow relative to diaphragm) delays the pressure signal as air flow is directed around an abrupt bend before interacting with the diaphragm under the converter cap 90. The horizontal or slightly angled approach as disclosed herein tends to distribute the pressure signal evenly across diaphragm resulting in better throttle response. As shown in FIGS. 6-8, inlet port 92 is positioned on side of converter cap 90. A transition region 94 promotes smooth air flow through port 92. In this embodiment, airflow through line 84 at port 92 is generally parallel to the diaphragm. An improvement in the responsiveness of engine 13 can be yielded by such positioning of port 92 relative to the diaphragm within converter 42.

FIG. 9 illustrates a naturally aspirated system 500 in accordance with the present invention. System 500 draws air through air intake and fuel through heater/converter 42 into mixer 43. An air/fuel mixture is drawn through plenum/intake manifold 45 into engine 13.

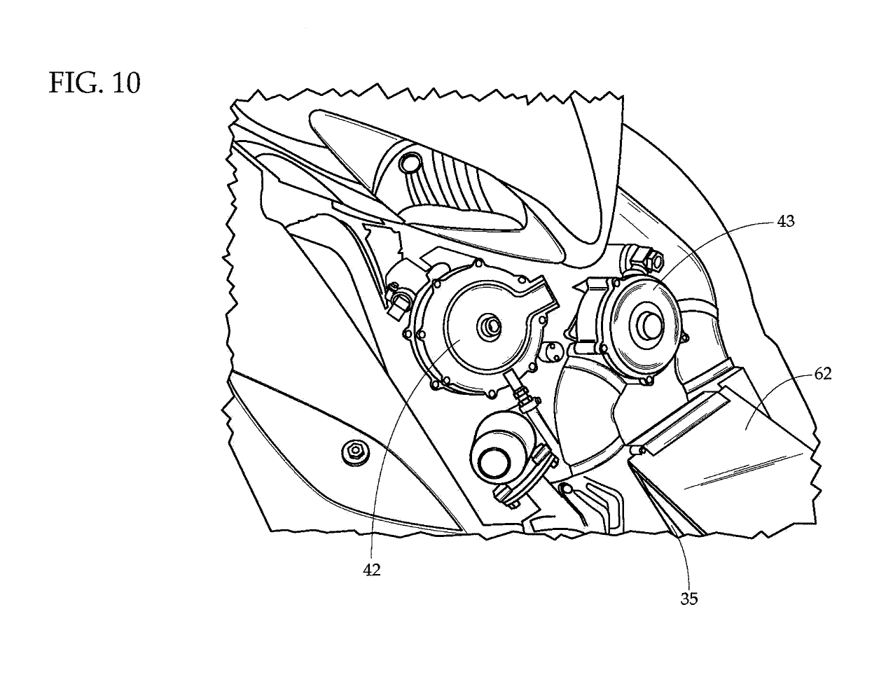

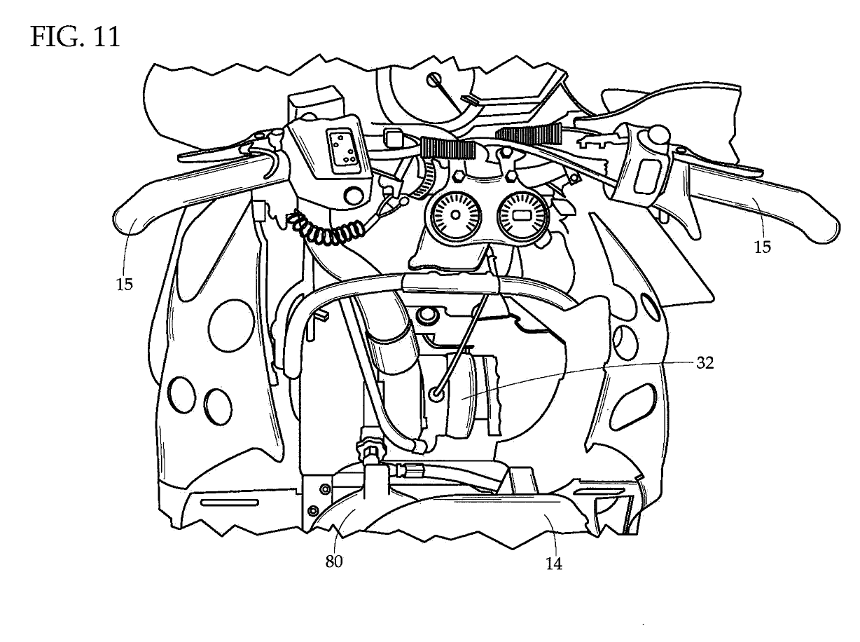

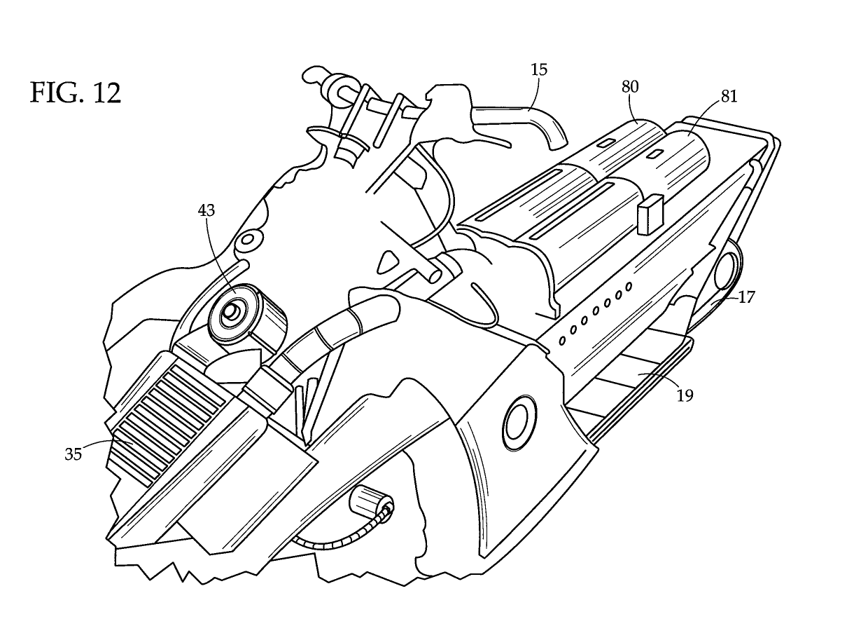

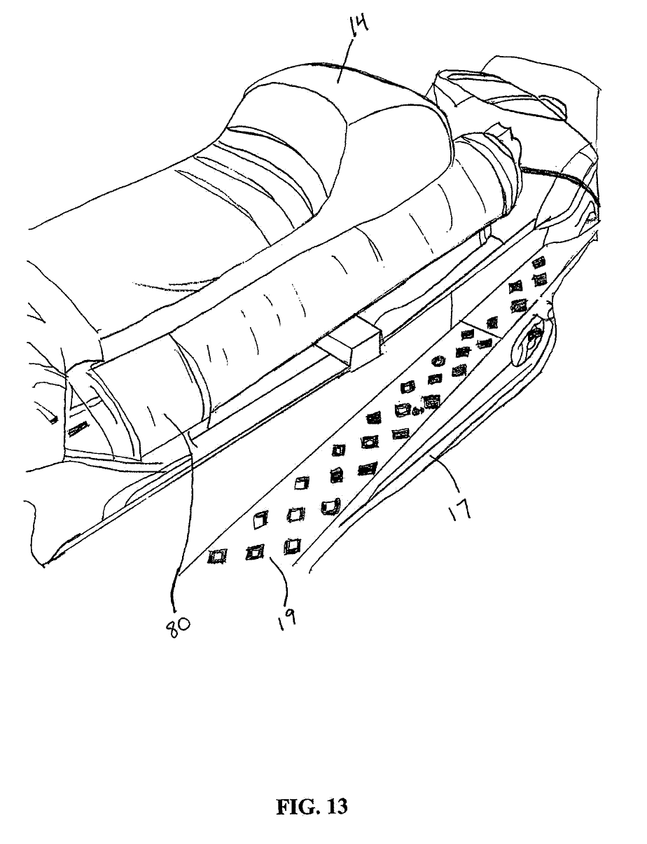

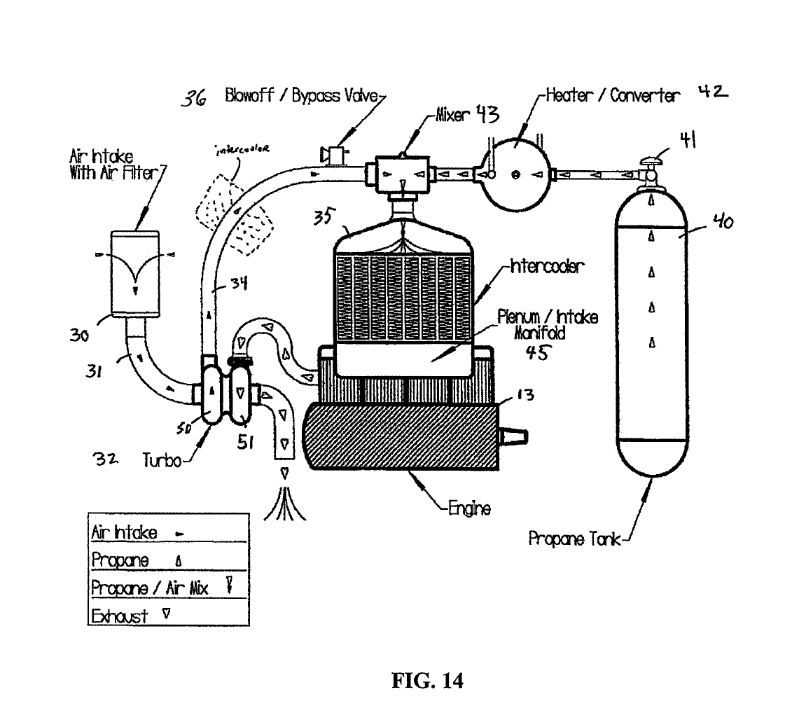

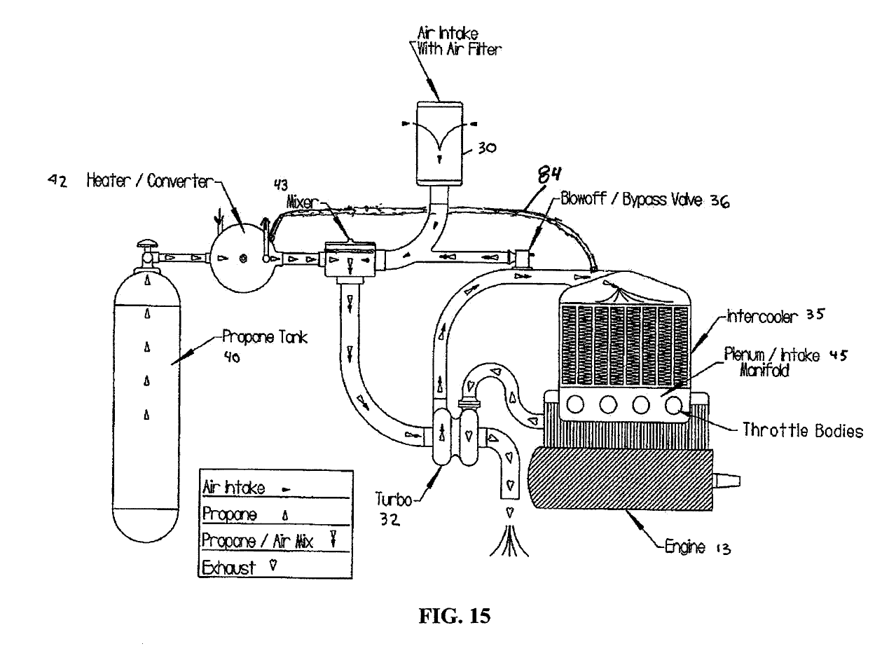

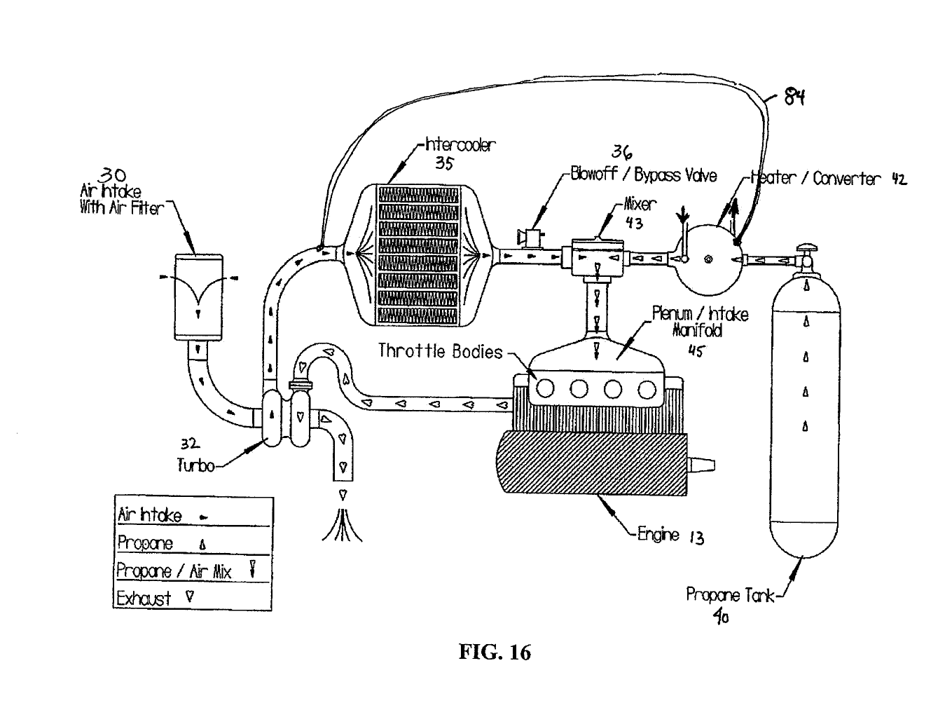

FIGS. 10-13 illustrate various component locations of another embodiment of a snowmobile incorporating aspects of the present invention. As shown in FIG. 9, cowl 62 directs air into intercooler 35. FIG. 10 illustrates the location of turbocharger 32, positioned between engine 13 and operator seat 14. FIGS. 11-13 show tank 40 conFIGUREd as a pair of generally cylindrical tanks 80, 81. Tanks 80, 81 are preferably positioned between the track tunnel and seat 14. Tanks 80, 81 can be in fluid communication with each other or a valve(s) could be used to access each tank separately. Fuel lines (not shown) direct fuel to the heater/converter 42, which, in this example, is within the engine compartment. Seat 14 may be coupled directly to tanks 80, 81 or may be coupled to frame 11. Tanks 80, 81 are preferably aligned with a direction of forward motion. Tank volume ranges from 2 to 40 gallons. Access to tanks 80, 81 may be provided by removal of seat 14. Alternatively, access for filling tanks 80, 81 may be provided at a readily accessible location without requirement of removing or moving seat 14 or other structure. In an illustrated embodiment, tanks 80, 81 are aluminum and welded together. Tanks 80, 81 may be a structural component as it may be possible that tanks 80, 81 could form part of frame 11. In the illustrated embodiment, tanks 80, 81 are generally horizontal and positioned between seat 14 and frame 11.

Tanks 80, 81 may be removable from frame 11, providing an operator to remove the tanks for filling or replacement. A suitable latch or locking mechanism could be used to retain the tanks during operation. One or more handles may be providing on the tanks to facilitate transport during refilling, replacement, etc. Tanks may be (optional) bolted permanently to the frame or tunnel portion of vehicle

Control of the engine system, including air charging system, and pressurized gas fuel regulation may be controlled by an electronic controller 100 receiving one or more inputs relating to, for example, pressure, temperature, engine knock, and emissions sensors.

Other vehicles may utilize aspects of the present invention. For example, a personal watercraft (PWC) may include a power plant in accordance with the present invention. Similar to a snowmobile operation, a PWC operator straddles a seat during machine operation. Foot rests are provided on either side of the PWC seat. One or more fuel tanks are provided under the PWC seat. The tanks may be cylindrical and extend along the longitudinal axis of the watercraft. Alternatively, one or more fuel tanks may also be located in front of bow or hull of PWC. A propane powered turbocharged internal combustion engine would be used to power the watercraft. Location of the intercooler, turbocharger, etc. could vary depending on the engine dimensions, hull design, seat configuration, etc. In this embodiment, the operator straddles the propane tanks during use. One or more tanks could be utilized. Again, one or more tanks could be selectively removable from the hull to facilitate filling or replacement. Suitable locking or latch mechanism could be used to retain the fuel tanks within the PWC.

Fuel tanks may be positioned at any angle relative to the direction of machine forward motion of the vehicle depending on the space constraints. For example, a plurality of gas tanks could be secured within the front hood of the snowmobile. Alternatively, a plurality of gas tanks could be secured underneath the operator seat. In one example, the gas tanks are aligned generally perpendicular to the direction of forward motion. In other examples, gas tanks could be positioned at other angles, e.g., vertical, etc.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A vehicle powered by an internal combustion engine, said vehicle comprising:
a source of pressurized fuel coupled to a frame, said fuel being a primary fuel for an IC engine providing power to the vehicle; and
a mixer for combining air with some of the fuel gas from said source prior to introduction into said engine, said engine powering the track to move the snowmobile across a ground surface during operation.

2. A vehicle comprising:
a frame;
an engine being coupled to the frame and driving a terrain-engaging element;
a seat, wherein an operator straddles the seat and portions of the frame and feet of the operator are supported by foot rests on either side of the frame when seated during vehicle operation; and
an elongated tank of pressurized gas extending along a substantial length of the frame, wherein the tank is located between the foot rests.

3. A recreational motor vehicle comprising:
a frame;
a engine coupled to the frame and driving a terrain-engaging element;
a seat, wherein an operator straddles the seat and portions of the frame and feet of the operator are supported by foot rests on either side of the frame when seated during vehicle operation; and
an elongated tank of pressurized liquefied fuel gas extending between the foot rests and extending in front of a seated operator in a direction of machine motion and further extending behind the seated operator opposite from the direction of machine motion.
